(19) United States
(12) Patent Application Publication
(10) Pub. No.: US 2015/0109134 A1
(43) Pub. Date: Apr. 23, 2015

(54) Surface-Attached Alerting Device

(71) Applicant: Magibrands, Inc., Woodinville, WA (US)

(72) Inventors: David L. Ratner, Santa Monica, CA (US); Jeff B. Glickman, Woodinville, WA (US)

(73) Assignee: Magibrands, Inc., Woodinville, WA (US)

(21) Appl. No.: 14/056,040

(22) Filed: Oct. 17, 2013

(51) Int. Cl. G08B 1/08

(52) U.S. Cl. CPC G08B 1/08
USPC 340/686.6

(57) ABSTRACT

A detection device includes a proximity sensing circuit that generates a chime activation signal responsive to a sensor activation signal; a loudspeaker; and a chime generator circuit coupled between the proximity sensing circuit and the loudspeaker, configured to control activation of the loudspeaker responsive to the chime activation signal. The chime generator circuit may include an in-system programming (ISP) connector having program pins adapted to receive a programming probe such that the chime generator circuit is programmable after being placed on a circuit board, the program pins including a program clock (PGC) pin. The detection device may also include a resistor connected between power supply of the chime generator circuit and the PGC pin, the resistor having a resistance such that the chime generator circuit: detects when the programming probe is attached to the PGC pin while sampling the voltage at the PGC pin, and suppresses chiming of the loudspeaker.

### BACKGROUND

1. Technical Field

The present disclosure generally pertains to alerting devices, and more particularly to an audio alerting device that is activatable by sensing proximity through a material to which it is attached, and which is programmable after placement on a circuit board.

2. Related Art

The use of an alerting device such as a door bell to indicate that a person wishes to enter a home or a commercial building is in widespread use. Typical alerting devices include hard-wired chimes, bells or buzzers (with associated activators) that are located within a home or a building and that are activated by a person from the outside of the home or the building structure.

### BRIEF DESCRIPTION OF THE DRAWINGS

The system may be better understood with reference to the following drawings and description. Non-limiting and non-exhaustive embodiments are described with reference to the following drawings. The components in the drawings are not necessarily to scale, emphasis instead being placed upon illustrating the principles of the present disclosure. In the drawings, like referenced numerals designate corresponding parts throughout the different views.

FIG. 1 is a block diagram of an example design of an electronics circuit of a surface-attached alerting device.

FIG. 2 is an elevational-cutaway view of an alerting device enclosure attached to an inside surface of a material (such as a wall, door, window) of a dwelling.

FIG. 3 is a front elevational view of the alerting device enclosure attached to the inside surface of the material of FIG. 2.

FIG. 4 is a rear elevational view of the alerting device enclosure attached to the inside surface of the material of FIG. 2.

FIG. 5 is a circuit diagram of the electronics circuit of FIG. 1.

FIG. 6 is a block diagram of a simplified, alternative design of the electronics circuit of FIG. 1.

FIG. 7 is a block diagram of a simplified design of the alerting device of FIG. 6 that uses a buzzer of an audio alerting device.

FIG. 8 is a flow chart of a method for detecting removal of a programming probe from an in-system programming (ISP) connector of a chime generator circuit.

### DETAILED DESCRIPTION

By way of introduction, this disclosure generally pertains to alerting devices, and more particularly to an audio alerting device that is activatable by sensing proximity through a material to which it is attached, and which is programmable after placement on a circuit board.

A resistor may be inserted between a power supply and a program clock pin (or pad) of a chime generator circuit, and sized to facilitate detection of a programming probe on an in-system programming (ISP) connector that includes the program clock pin. Upon detection, the chime generator circuit may suppress the activation of a loudspeaker coupled with the chime generator circuit, to prevent damaging the alerting device during in-system programming. The ISP connector may be used to program a chime generator circuit, in terms of when, how and whether to chime a loudspeaker, which will be discussed in more detail. The term “coupled with” herein is defined to mean connected to another component, whether directly or indirectly through one or more additional, different electrical components.

The alerting device may also be also adapted with a capacitor having a large capacitance integrated within a proximity-sensing circuit that operates in saturation, to increase sensitivity of sensing proximity through numerous materials with differing dielectric constants.

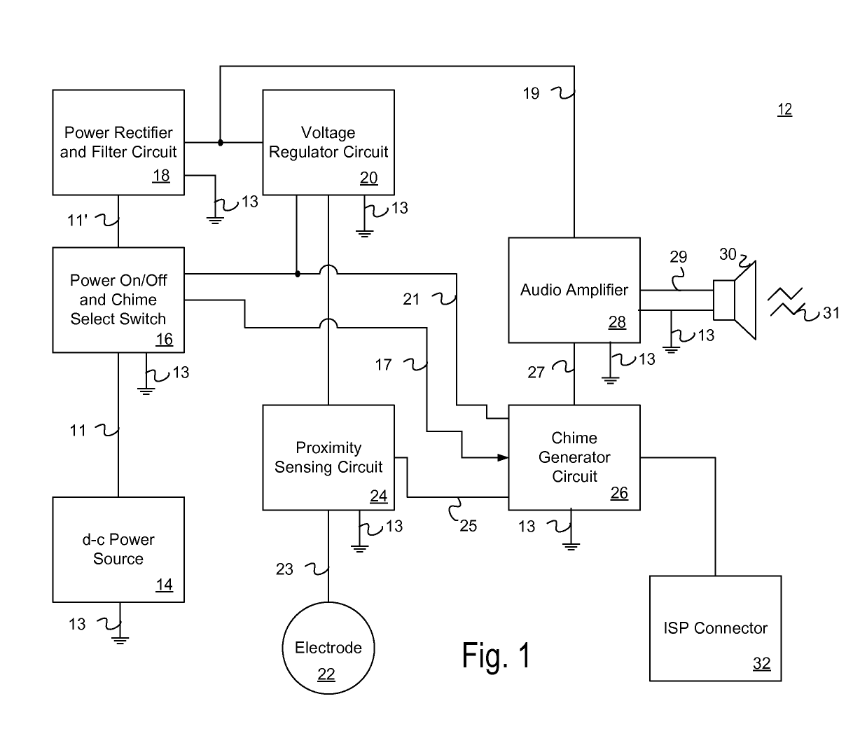

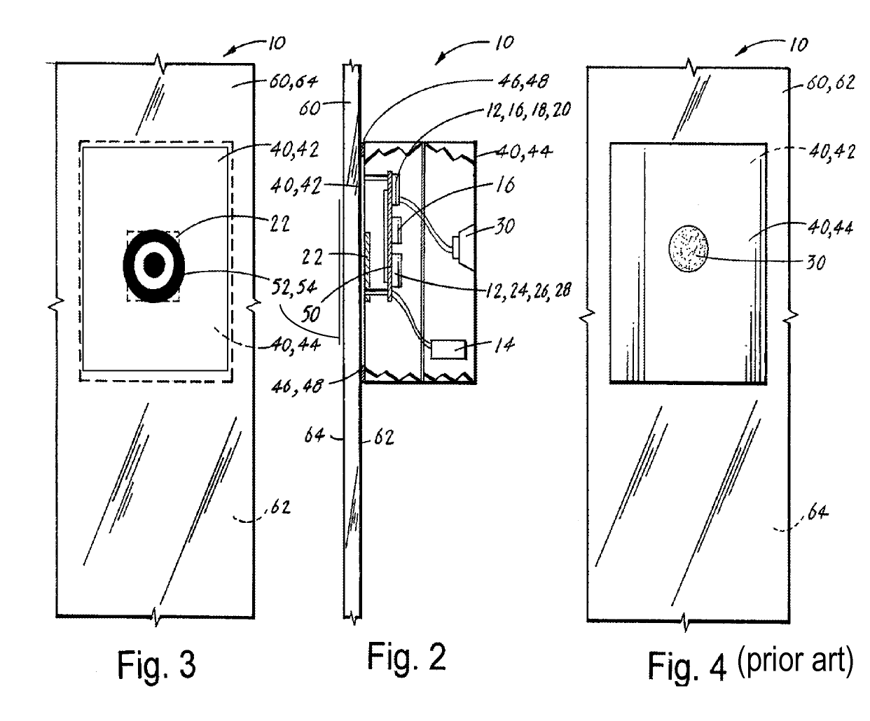

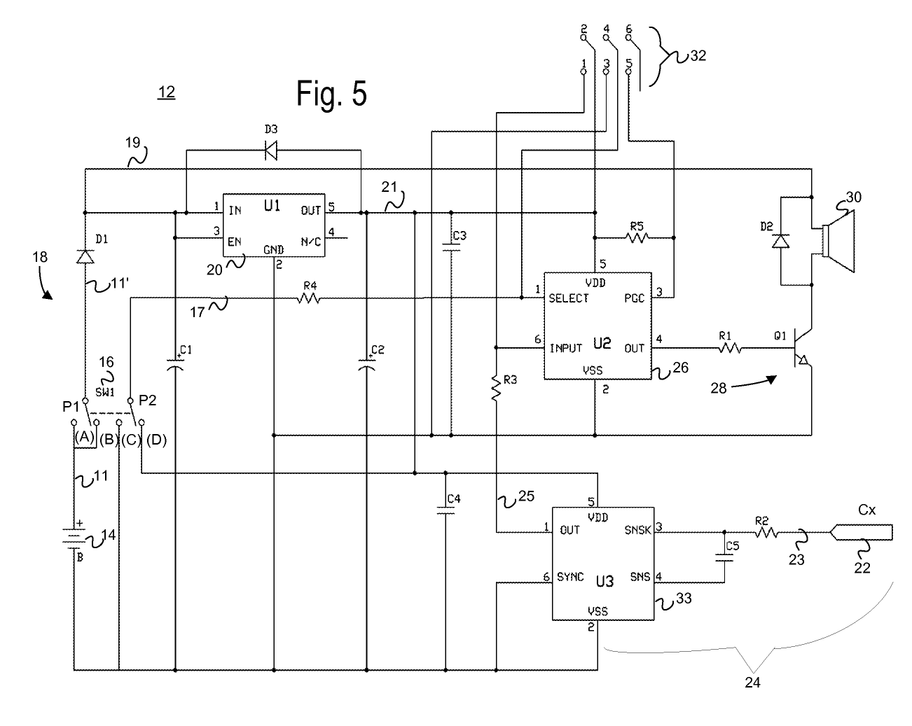

The alerting device may be implemented in multiple configurations. FIG. 1 is a block diagram of an example design of an electronics circuit 12 of a surface-attached alerting device 10 (FIGS. 2-4), and FIG. 5 shows a more complete circuit diagram of the alerting device. The electronics circuit 12 may include, but not be limited to: a d-c power source 14; a power ON/OFF and chime select switch 16; a power rectifier and filter circuit 18; a voltage regulator circuit 20; an electrode 22; a proximity sensing circuit 24; a chime generator circuit 26; an audio amplifier 28; a loudspeaker 30; and, an in-system programming (ISP) connector 32 connected to the chime generator circuit 26. As will be discussed, the proximity sensing circuit 24 and the chime generator circuit 26 may be combined into a single microcontroller or chip. Furthermore, the components of the electornics circuit 12 may be completely instatiated on one or more printed circuit board (PCB).

The alerting device 10 may further include a device enclosure 40, as is shown in FIGS. 2-4. The enclosure 40 may include, in part, an outer side 42, an inner side 44, attachment means 46, and an indicia 52 that may be viewable through a transparent material. The alerting device 10 may function in combination with a material 60 having an inner surface 62 and an outer surface 64. The electronics circuit 10 that operates the alerting device may be located within the enclosure 40. The outer side 42 may be removably attached to the inner surface 62 of a material, which allows the inner side of the enclosure to extend from the inner surface 62 of the material such as a door, wall or window (and the like) of a building.

To activate the alerting device 10, a person simply places his/her finger or hand proximate to an indicia such as a target (e.g., a sticker, painted circle, etc.) that is placed on the outer side of the material, or that is visible through a window or door where the material is transparent. The alerting device may be a chime, a buzzer, an audio message, or the like. However, for purposes of brevity, only an alerting device that uses a chime and/or a buzzer is disclosed.

With more particularity, the d-c power source 14 may include means for producing a d-c supply voltage 11 that can range from 2 to 30 volts. (Although the d-c power source is first disclosed, an a-c power source may also be supplied, as will be discussed.) A 9-volt battery may supply the d-c supply voltage. Alternatively, or additionally, AA batteries or another combination of batteries may be used to supply the d-c supply voltage. For example, the diode D1 (which is part of the power rectifier and filter circuit 18) may be a low dropout Schottky blocking diode rather than a standard diode, which makes possible use of one or more AA, 1.5 v 2000 ma hour batteries instead of a 9 v, 500 ma hour battery. This change to the one or more AA batteries may quadruple the battery life available to the alerting device.

The d-c supply voltage may be controlled by the power ON/OFF and chime select switch 16, which may include a double-pole, double-throw, center off switch such as a slide switch (best seen in FIG. 5). The switch 16 may include a first pair of contacts (A) and (B) that are selected by a first pole (P1), and a second pair of contacts (C) and (D) that are selected by a second pole (P2). The contacts (A) and (B) may be connected together and are applied the d-c supply voltage from the d-c power source 14. The contact (C) may be connected to circuit ground 13, and the contact (D) may be applied a regulated d-c voltage from the voltage regulator circuit 20 as will be described. The first pole (P1) may be ganged to the second pole (P2), indicated by the dashed line. A switched d-c supply voltage 11′ may be produced from the first pole (P1), and a chime generated mode select signal 17 by be produced from the second pole (P2).

The switched d-c supply voltage 11′ may be sent to the power rectifier and filter circuit 18. Diode D1 may rectify the voltage 11′ and capacitor C1 may filter the switched d-c supply voltage 11′ applied from the pole (P1) of the switch 16, producing a filtered d-c voltage 19. The power rectifier and filter circuit 18 may accept the switched d-c supply voltage 11′ or an a-c voltage. The diode D1 may rectify the a-c voltage to produce the filtered d-c voltage 19 and protect the circuit 12 from reverse polarity across the one or more battery 14.

The filtered d-c voltage 19 may be sent to the voltage regulator circuit 20, which may be configured to produce a regulated d-c voltage 21. (The voltage regulator circuit 20 may be a low dropout voltage regular (“LDO”).) This regulated d-c voltage 21 may be applied to the contact (D) of the power ON/OFF and chime select switch 16, to the proximity sensing circuit 24, and to the chime generator circuit 26. The voltage regulator circuit 20 may be a low-dropout adjustable voltage regulator that maximizes the useful life of the one or more batteries 14 used in the electronic circuit 12.

The electrode 22 may be composed of a metal that has a high dielectric constant. The electrode 22 may be attached to the inside of the outer side 42 of the electronics enclosure 40, or printed directly on the circuit board. When a finger or hand is placed proximate to an area on the electronics enclosure 40 that encompasses the electrode 22, the electrode 22 may sense a change in capacitance. This change in capacitance causes the electrode 22 to produce a sensor activation signal 23. The chime generator circuit 26 may include a capacitance to digital converter (CDC) that may generate a chime activation signal in response to receipt of the sensor activation signal 23.

The proximity sensing circuit 24 may include a proximity sensing integrated circuit (“IC”) 33, a sensing capacitor (C5), a sensing resistor (R2) and a load capacitance (Cx) of the electrode 22. The proximity sensing IC 24 may be a touch sensor IC, or the touch sensing function can be integrated into the chime generator circuit 26. The regulated d-c voltage 21 from the voltage regulator 20 may be supplied to the proximity sensing IC 24 along with the sensor activation signal 23 from the electrode 22.

The C5 capacitor may be designed with a capacitance to operate in saturation or deep saturation. Operating C5 in saturation increases sensitivity of the proximity sensing circuit 24. The Cx load capacitance may be proportional to a dielectric constant of the material to which is attached the sensing device 10. A larger Cx generally requires a larger s value to maintain the proper constraint that the sensing capacitor be larger than the load capacitance (Cx).

The regulated d-c voltage 21 and the chime generator mode select signal 17 may be sent to the chime generator circuit 26. The chime generator circuit 26 may be (or include) a flash microcontroller that is activated when the chime activation signal 25 is applied, and depending upon the position of the pole (P2), the ON/Off chime select switch 16 will produce a chime audio signal 27. For example, when the pole (P2) makes contact with the contact (C) (circuit ground), the chime generator circuit 26 may produce a “DING DONG” sound. When the pole (P2) makes contact with the contact (D) (high), the circuit 26 may produce a “DONG DING” sound. The filtered d-c voltage 19 and the chime audio signal 27 may be sent to the audio amplifier 28, which in response thereto, may produce an amplified audio signal 29 that is sent to the loudspeaker 30 from where the alerting device signal 31 is heard.

With further reference FIGS. 2, 3 and 4, the enclosure 40 may be dimensioned to enclose a printed circuit board (PCB) 50 to which is attached the major components that make up the electronics circuit 12, which may also include the speaker 30 and the electrode 22.

The alerting device enclosure 40 may be composed of an outer side 42 that is removably attached to an inner side 44 (FIG. 2). The enclosure 40 may include an attachment means 46 that may be a double-sided adhesive tape 48, with which to attach the enclosure 40 to a wall, door, window or the like. The tape (48) may be attached to the outer side of the enclosure 40, for example, near the upper edge and lower edge of the outer side 42. When the outer side 42 is pressed against the inner surface 62 of the material 60, the two-sided adhesive tape 48 securely attaches the alerting device enclosure 40 to the material 60.

The outer side 42 of the alerting device enclosure 40 may further include an indicia 52 such as a target 54 (FIGS. 2 and 3). The target 54 may be located so that it encompasses the location of the electrode 22, and be viewable through a transparent material, as indicated by the dashed enclosure 40 (FIG. 3). The indicia 52 may also be moved to the opposite side of the enclosure 40 across a door or wall acting as the material 60, indicated by the solid enclosure 40 (FIG. 3). The indicia 52 (or target 54) encourages a person to place his/her finger or hand at an optimum location to activate the surface-attached alerting device 10.

Because the chime generator circuit 26 may be a programmable microprocessor soldered directly onto a printed circuit board (PCB), the chime generator circuit may be programmed after designed onto the PCB, e.g., after manufacturing the electronics circuit 12. To reduce costs, a less expensive microprocessor may be used that shares pins with other parts of the microprocessor. One example of such a microprocessor may include, but not be limited to a 6-pin microcontroller chosen. These microcontrollers may be flash re-programmable. Additionally or alternatively, another programmable logic controller (PLC) or the like may be employed.

The pins or pads of the in-system (ISP) programming connector 32 may include, but not be limited to, as follows: (1) master clear (MCLR) and voltage for programming (VPP); (2) positive supply voltage (VDD); (3) negative supply voltage, or ground (VSS); (4) program data (PGD); and (5) program clock (PGC).

Coming out of reset, the chime generator circuit 26 may execute stored programs in a certain order. Directly after external programming (via ISP), the chime generator circuit 26 may come out of reset and execute the program having just been programmed. But, this also happens at power up. To react properly, and protect the electronics circuit 12, the chime generator circuit 26 should determine whether the controller is coming out of power up or if it is coming out of external program via ISP. The chime generator circuit 26 may then execute the correct of two separate programs, one for powering up and one for ISP, respectively.

More particularly, when there is a probe of a programming device (“external programmer”) located on the ISP connector 32 of the chime generator circuit 26, the programming device supplies the DC power (via the ISP connector) to the electronics circuit 12. This creates a significant risk that the voltage regulator circuit 20 may fail if the chime generator circuit signals to chime the loudspeaker as a reverse voltage bias may be present across the voltage regulator circuit 20 because of the excessive current required to chime the speaker. This reverse voltage bias may cause the output voltage at pin 5 of the LDO within the voltage regulator circuit 20 to be higher than the input voltage at pin 1, and this reverse bias condition could burn up the voltage circuit regulator 20, and possibly also damage the programming device applied to the chime generator circuit.

Accordingly, although not recommended by the microcontroller vendors of the chime generator circuit 26, the R5 resistor may be added—along with additional program code programmed onto the chime circuit generator—to act as an ISP detector. The detection may be achieved where the additional program code is configured to sample the voltage level of the program clock (PGC) pin from the external programmer, and thus detect a legal low voltage (of 0.2 volts or lower, for example) as the external programmer finishes programming the chime generator circuit 26.

The new program code may be executed instead of the power up program under ISP detection conditions when the chime generator circuit 26 has been programmed by an external programmer (or probe). This new program may then suppress chiming the loudspeaker 30 to avoid the reverse bias condition previously discussed.

The R5 resistor is not recommended by vendors because the external programmer uses an internal pull down resistor (e.g., of between about 3.7K-ohms to about 5.7K-ohms) on the PGC and PGD lines. The placement of resistor R5 between the Vdd and PGC pin (or pad) creates a voltage divider at the PGC input pin of the chime generator circuit 26. Accordingly, the value of R5 may impact both ISP and not ISP conditions, making proper functioning difficult to obtain in the presence of the R5 resistor.

More specifically, for ISP detection, the chime generator circuit 26 is programmed to detect the presence of the program clock (PGD), which as will be explained, involves detecting a certain legal low voltage level. And, for non ISP detection when coming out of circuit power up, the chime generator circuit 26 may need to still detect a legal logic high level.

The logic low level may be affected by the voltage divider caused by R5 and the pull down resistor in the external programmer. At ISP, the PGC pin of the chime generator circuit 26 may go into Schmitt trigger mode and the logic low detection levels may drop to 0.2 volts from 0.8 volts, for example. The resultant divided voltage would need to be below 0.2 volts at logic low to be detected. With use of a resistor R5 between about 370K-ohms and about 570K-ohms, a logic low level could still be detected. For example, assuming the external programmer has a pull down resistor of 4.7K-ohm and that a 470K-ohm resistor were used for R5, the voltage divider would generate a logic low of 0.050 volts when Vdd is at 5 volts from the external programmer, which is clearly below the 0.2 volts needed for a logic low voltage level, indicating the ISP condition presence of the external programmer.

Simultaneously, however, there may also be a maximum allowable condition value of R5 due to requirement of the not ISP condition. For not ISP, the chime generator circuit 26 may have to detect a logic high level when coming out of power up. The I/O ports of the chime generator circuit 26 may have an inherent leakage current of up to 1 micro-amp in a worst case. Accordingly, any pull up resistor will cause a voltage drop that will be present at the PGC pin. The R5 resistor should be sized low enough so that the resultant voltage does not drop below the legal logic high level. This circuit may use a three-volt (3V) power supply, for example. By way of example, the 470K pull up resistor would create roughly a 0.47 volt drop across it (0.000001 amp×470,000 ohms=0.47 volts). Accordingly, assuming a three volt circuit power supply, the voltage present at the PGC pin (or pad) during the not ISP condition would drop to 2.53 volts (3 volts−0.47 volts), which is still well within the logic of high detection range of 2 volts.

In summary, with proper choice of the R5 resistor placed between the PGC pin (or pad) (3) and the regulated power supply of the chime generator circuit 26, a new program on the chime generator circuit 26 may be executed to detect the ISP condition by sampling the voltage at the PGC pin, and to suppress chiming the loudspeaker in response thereto, such as to avoid a reverse bias condition across the voltage regular circuit 20 that may damage the electronic circuit 12.

By way of further protection, a Schottky bypass diode in a reverse bias configuration (diode D3) may also be added across the low dropout voltage regulator circuit 20. This LDO bypass diode (D3) may provide additional safety by protecting the voltage regular circuit 20 from reverse polarity conditions due to external devices (for programming or for any other purpose).

Furthermore, a Schottky bypass diode (D2) may be placed across the loudspeaker 30. The bypass diode D2 may provide added protection as a bypass path for the “fly-back” discharge current from the loudspeaker 30. Using the same diode type as for diode D3 helps to save on production costs by preventing the need for a reel change on an surface-mounted (SMT) ‘pick-and-place’ machine during manufacturing. Having diodes D2 and D3 be the same part also saves on purchase costs by doubling the part count per each electronics circuit 12, which provides a better discount price because a larger (double) quantity may be purchased for the same number of electronic circuits 12 going into alerting devices 10.

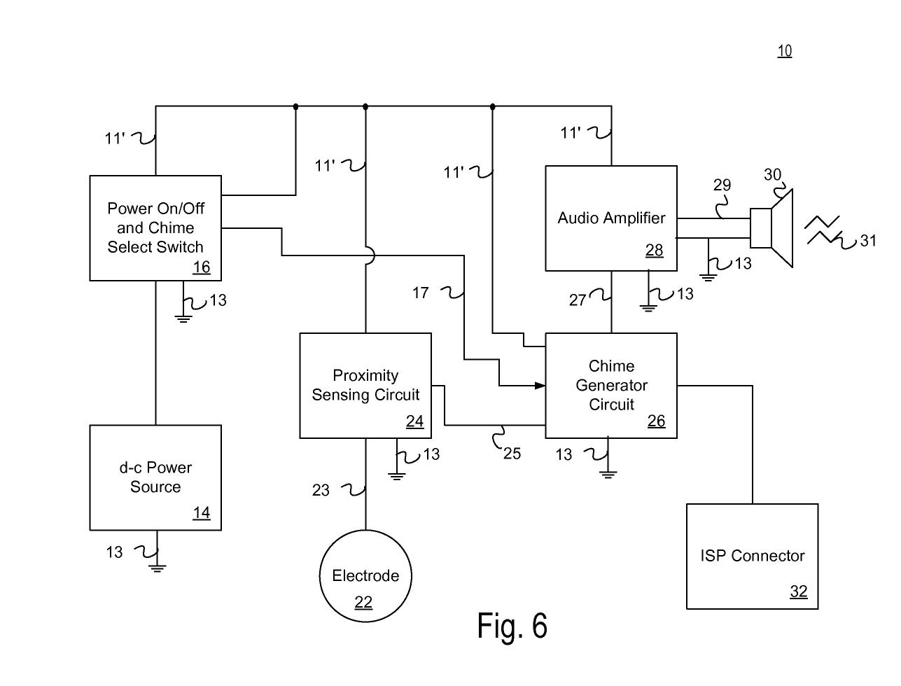

An alternative design of the electronics circuit 12 of the alerting device 10 is shown in FIG. 6. Here, the power rectifier and filter circuit 18 and the voltage regulator 20 have been eliminated from the circuit design, but otherwise remains the same. In this case, the filtered d-c voltage 19 is not generated and the regulated d-c voltage 21 is not generated. Accordingly, in this alternative design, the audio amplifier 28, the chime generator circuit 26 and the proximity sensing circuit 24 may all be powered by the switched d-c supply voltage 11′ from the pole, P1, of the switch 16. The mode select signal 17 is likewise sent from the pole P2 of the switch 16 to the chime generator circuit 26.

The chime generator circuit 26 may include a flash microcontroller that is activated when the chime activation signal 25 is applied, and depending upon the position of the pole, P2, the power ON/Off chime select switch 16 may produce a chime audio signal 27.

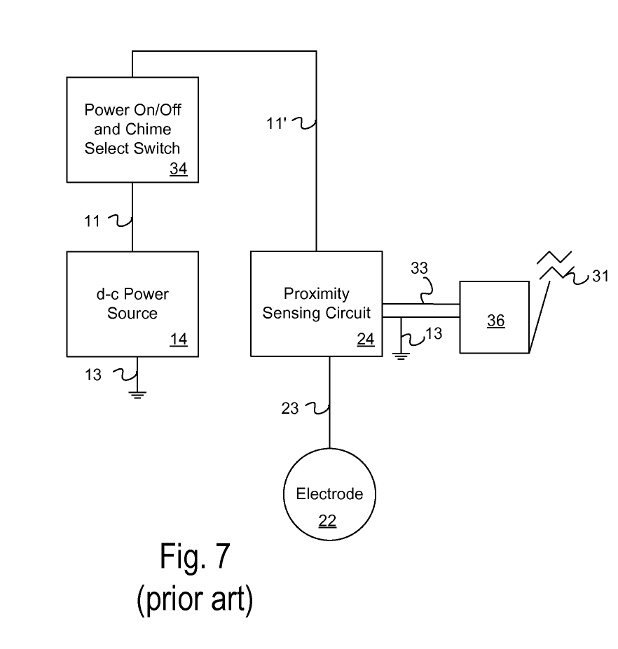

Another alternative design of the electronics circuit 12 of the alerting device 10 is shown in FIG. 7, in which the chime generator circuit 26 is removed. The electronics circuit 12 in the design of FIG. 7 may include, but not be limited to, a d-c power source 14, a power ON/OFF switch 34 (such as a single-pole ON/OFF switch), an electrode 22, a proximity sensing circuit 24 and a buzzer 36.

The d-c supply voltage 11 is applied to and is controlled by the power ON/OFF switch 34. When the switch 34 is open, no power is applied to the electronics circuit 12. Conversely, when the power switch 34 is closed, the d-c supply voltage is applied through the switch 34 to produce a switched d-c voltage 11′.

The switched d-c voltage 11′ may then be applied to the proximity sensing circuit 24 as well as the sensor activation signal 23 from the electrode 22. The proximity sensing circuit 24 may incorporate an integrated circuit that includes a capacitance to digital converter (CDC) that, when the circuit 24 is receives the sensor activation signal 23, may generate a buzzer activation signal 33 that is sent to the buzzer 34, which produces the alerting device signal 31.

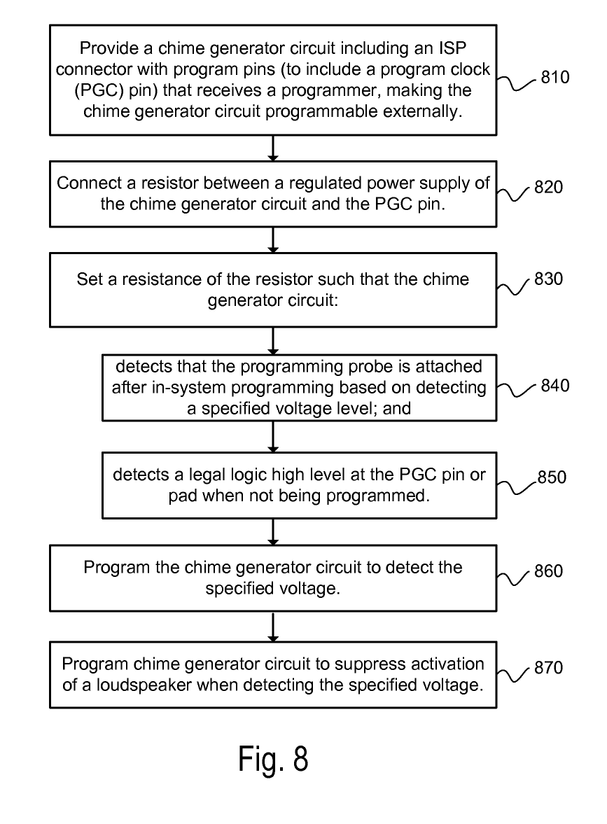

FIG. 8 is a flow chart of a method for detecting presence of a programming probe from an in-system programming (ISP) connector of a chime generator circuit. The method includes providing a chime generator circuit including an in-system programming (ISP) connector having program pins adapted to receive a programming probe such that the chime generator circuit is programmable after being placed on a circuit board of a surface-attached detection device, the program pins including a program clock (PGC) pin (810). The method may further include connecting a resistor between a regulated power supply of the chime generator circuit and the PGC pin (or pad) (820). The method may further include setting a resistance of the resistor (830) such that the chime generator circuit: (i) detects that the programming probe is attached after in-system programming based on detecting a specified voltage level at the PGC pin (840); and (ii) detects a legal logic high level at the PGC pin when not being programmed (850). The method may further include programming the chime generator circuit to detect the specified voltage (860). The method may further include programming the chime generator circuit to suppress activation of a loudspeaker of the detection device upon detecting the specified voltage (870).

The chime generator circuit 26 and/or the proximity sensing circuit 24 may be a microprocessor, a microcontroller or a programmable logic controller, which may include one or more general processors, digital signal processors, application specific integrated circuits, field programmable gate arrays, digital circuits, optical circuits, analog circuits, combinations thereof, or other now known or later-developed devices for analyzing and processing data. The circuits 24 and 26 may implement a set of instructions or other software program, such as manually-programmed or computer-generated code for implementing logical functions, and may be the same integrated circuit device. The logical function or any system element described may, among other functions, process and/or convert an analog data source such as an analog electrical, optical, audio, or video signal, or a combination thereof, to a digital data source for audio-visual purposes or other digital processing purposes such as for compatibility for computer processing.

The chime generator circuit 26 and/or the proximity sensing circuit 24 may include a memory 304, which may be flash programmable for example, and may also include computer-readable media. A “computer-readable medium,” “computer-readable storage medium,” “machine readable medium,” “propagated-signal medium,” and/or “signal-bearing medium” may include any device that includes, stores, communicates, propagates, or transports software for use by or in connection with an instruction executable system, apparatus, or device. The machine-readable medium may selectively be, but not limited to, an electronic, magnetic, optical, electromagnetic, infrared, or semiconductor system, apparatus, device, or propagation medium. The chime generator circuit 26 and/or the proximity sensing circuit 24 may be realized in hardware, software, or a combination of hardware and software.

The system may also be embedded in a computer program product, which includes all the features enabling the implementation of the operations described herein and which, when loaded in a computer system, is able to carry out these operations. Computer program in the present context means any expression, in any language, code or notation, of a set of instructions intended to cause a system having an information processing capability to perform a particular function, either directly or after either or both of the following: a) conversion to another language, code or notation; b) reproduction in a different material form.

The above-disclosed subject matter is to be considered illustrative, and not restrictive, and the appended claims are intended to cover all such modifications, enhancements, and other embodiments, which fall within the true spirit and scope of the present disclosure. Thus, to the maximum extent allowed by law, the scope of the present embodiments are to be determined by the broadest permissible interpretation of the following claims and their equivalents, and shall not be restricted or limited by the foregoing detailed description. While various embodiments have been described, it will be apparent to those of ordinary skill in the art that many more embodiments and implementations are possible within the scope of the above detailed description. Accordingly, the embodiments are not to be restricted except in light of the attached claims and their equivalents.

1. A surface-attached detection device, comprising:
a proximity sensing circuit configured to generate a chime activation signal responsive to receipt of a sensor activation signal;
a loudspeaker;
a chime generator circuit coupled between the proximity sensing circuit and the loudspeaker and configured to control activation of the loudspeaker responsive to the chime activation signal;
the chime generator circuit including an in-system programming (ISP) connector comprising program pins adapted to receive a programming probe such that the chime generator circuit is programmable after being placed on a circuit board, the program pins including a program clock (PGC) pin; and
a resistor connected between a regulated power supply of the chime generator circuit and the PGC pin, the resistor having a resistance such that the chime generator circuit detects the presence of the programming probe at the PGC pin while sampling the voltage at the PGC pin.

2. The detection device of claim 1, where the chime generator circuit is configured to suppress activation of the loudspeaker when the programming probe is present, after completion of in-system programming of the chime generator circuit.

3. The detection device of claim 1, where the resistor comprises a resistance between about 370,000 ohms and 570,000 ohms.

4. The detection device of claim 3, where the resistor has a resistance of 470,000 ohms.

5. The detection device of claim 1, where the program clock pin goes into Schmitt trigger mode when the chime generator circuit detects a low logic level voltage at the time the programming probe is attached to the ISP connector, and the resistance is set such that a divided voltage causes a voltage at the PGC pin of about 0.2 V or lower when detecting the low logic level voltage.

6. The detection device of claim 1, where the resistance is set such that a divided voltage across the resistor is such that a high logic level voltage of at least 2.0 volts is detected at the PGC pin at power up.

7. The detection device of claim 1, where the chime generator circuit executes first logic to control the loudspeaker based on the sensor activation signal, and executes second logic different than the first logic upon detecting attachment of the programming probe to the ISP connector, the second logic configured to suppress activation of the loudspeaker when a logic level consistent with the presence of the programing probe is detected at the PGC pin.

8. The detection device of claim 1, further comprising:
a power source;
a voltage regulator circuit; and
a first Schottky blocking diode located between the power source and the voltage regulator circuit to rectify the voltage coming from the power source and to provide reverse polarity protection from the DC power source.

9. The detection device of claim 8, further comprising:
a second Schottky bypass diode connected in reverse polarity across the plus and minus terminals of the loudspeaker, to protect against fly-back discharge current from a coil of the loudspeaker.

10. A proximity sensing circuit of surface-attached detection device, comprising:
an electrode;
a proximity sensing integrated circuit (IC) coupled with the electrode;
a resistor connected between the electrode and the proximity sensing IC;
a capacitor connected across sense pins of the proximity sensing IC and to the resistor, the capacitor having a capacitance larger than a load capacitance of the electrode as attached to a surface, and where the capacitance is set so that the capacitor operates in saturation, which increases sensitivity to sensing proximity of a human digit to the electrode through a material that includes the surface to which is attached the detection device.

11. The proximity sensing circuit of claim 10, where the load capacitance of the surface is proportional to a dielectric constant of the surface.

12. The proximity sensing circuit of claim 10, where the capacitor is configured with a capacitance such as to operate in deep saturation.

13. The proximity sensing circuit of claim 10, where the proximity sensing circuit further includes an output that generates a sensor activation signal responsive to proximity of a human digit to the electrode.

14. A method comprising:
providing a chime generator circuit including an in-system programming (ISP) connector comprising program pins adapted to receive a programming probe such that the chime generator circuit is programmable after being placed on a circuit board of a surface-attached detection device, the program pins including a program clock (PGC) pin;
connecting a resistor between a power supply of the chime generator circuit and the PGC pin;
setting a resistance of the resistor such that the chime generator circuit: (i) detects when the programming probe is attached to the PGC pin after in-system programming based on detecting a specified voltage level at the PGC pin; and (ii) detects a legal logic high level at the PGC pin when not being programmed; and
programming the chime generator circuit to detect the specified voltage.

15. The method of claim 14, further comprising:
programming the chime generator circuit to suppress activation of a loudspeaker of the detection device when detecting the specified voltage.

16. The method of claim 14, where the PGC pin goes into Schmitt trigger mode when the chime generator circuit detects a low logic level voltage at the time the programming probe is attached to the ISP connector, and where setting the resistance further comprises:
setting the resistance of the resistor such that a divided voltage causes a voltage at the program clock pin of about 0.2 V or lower when detecting the low logic level voltage.

17. The method of claim 14, where setting the resistance further comprises:
setting the resistance such that a divided voltage across the resistor is such that a high logic level voltage of 2.0 volts or higher is detected at the program clock pin.

18. The method of claim 14, further comprising:
generating a chime activation signal by a proximity sensing circuit in response to receipt of a sensor activation signal from a sensor;
causing the chime generator circuit to execute first logic to control a loudspeaker based on receipt of the chime activation signal; and
executing second logic different than the first logic upon detecting the programming probe attached to the ISP connector, the second logic configured to suppress activation of the loudspeaker when a logic level consistent with the presence of the programing probe is detected at the PGC pin.
